(19) United States
(12) Patent Application Publication
(10) Pub. No.: US 2024/0221521 A1
(43) Pub. Date: Jul. 4, 2024

(54) COLLECTION OF CONTEXT INFORMATION FOR QUESTIONING

(71) Applicant: Lenovo (United States) Inc., Morrisville, NC (US)

(72) Inventors: Allen Richey, Frisco, TX (US); Matthew Fardig, Boonville, IN (US); Inna Zolin, Cary, NC (US)

(21) Appl. No.: 18/090,649

(22) Filed: Dec. 29, 2022

(51) Int. Cl. G09B 5/14; G09B 5/06

(52) U.S. Cl. CPC G09B 5/14; G09B 5/06

(57) ABSTRACT

One embodiment provides a method, the method including: receiving, at an alert context identification system, an alert initiated by one of a plurality of user devices in operative communication with a central device operated by a presenting user, wherein the alert indicates a user of the one of the plurality of user devices wants to communicate at least with the presenting user; determining, utilizing the alert context identification system, a context occurring at a time of the alert; and providing, to the central device and utilizing the alert context identification system, the context with the alert. Other aspects are claimed and described.

### BACKGROUND

With the increase in virtualization, more meetings are being conducted using remote communication connections and software that facilitates the meetings. One area that has seen a surge in virtualization is school or other classroom settings. Rather than all students and a teacher being physically located in the same space, the teacher can be located in one physical location and one or more of the students can be located in different physical locations. Classroom management software is employed to allow the teacher to transmit information to the student devices simultaneously. The classroom management software allows both the presenter and the students to provide some input. For example, a student may provide an input at the student device that indicates to the teacher and/or teacher device that the student has a question or wants to provide input regarding the presentation or topic.

### BRIEF SUMMARY

In summary, one aspect provides a method, the method including: receiving, at an alert context identification system, an alert initiated by one of a plurality of user devices in operative communication with a central device operated by a presenting user, wherein the alert indicates a user of the one of the plurality of user devices wants to communicate at least with the presenting user; determining, utilizing the alert context identification system, a context occurring at a time of the alert; and providing, to the central device and utilizing the alert context identification system, the context with the alert.

Another aspect provides an information handling device, the information handling device including: a processor; a memory device that stores instructions that when executed by the processor, causes the information handling device to: receive, at an alert context identification system, an alert initiated by one of a plurality of user devices in operative communication with a central device operated by a presenting user, wherein the alert indicates a user of the one of the plurality of user devices wants to communicate at least with the presenting user; determine, utilizing the alert context identification system, a context occurring at a time of the alert; and provide, to the central device and utilizing the alert context identification system, the context with the alert.

A further aspect provides a product, the product including: a computer-readable storage device that stores executable code that, when executed by the processor, causes the product to: receive, at an alert context identification system, an alert initiated by one of a plurality of user devices in operative communication with a central device operated by a presenting user, wherein the alert indicates a user of the of the one of the plurality of user devices wants to communicate at least with the presenting user; determine, utilizing the alert context identification system, a context occurring at a time of the alert; and provide, to the central device and utilizing the alert context identification system, the context within the alert.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for providing the context with an alert to the central device of a presenter by use of the alert context identification system.

FIG. 4A illustrates an example raised-hand gesture received during a virtual meeting as seen by a user in operative communication with a central device of a presenting user.

FIG. 4B illustrates an example raised-hand gesture received during a virtual meeting as seen by a presenting user in communication with a plurality of users.

FIG. 5A illustrates an example raised-hand gesture received via a chat window present in the graphical user interface of a virtual meeting as seen by the user.

FIG. 5B illustrates an example method of providing additional information from the user device in support of the question provided.

FIG. 6. illustrates an example raised-hand gesture received during a virtual meeting and suggesting a response to the user based upon previously supplied information as seen by the presenting user.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

A common practice in a classroom or in the workplace is the presenting of information from a single presenting user to plurality of attending users. In such environments, the presenting user may supply information originally unknown to the attendees in order to enlighten the users on such topics being deemed important. As is present in any education environment, questions from the attending users back to the presenting user associated with the information being relayed in an attempt to further their understanding of the information will occur. This asking of questions may assist with instilling the information into the attendees; however, the asking of questions may become a nuisance when an amount of questions is excessive and/or a repetition of information continually occurs. For example, when a teacher is presenting information to a classroom of students, if each student is being attentive to the information being presented and few questions are asked during a presentation, then the asking and the answering of questions may assist with understanding the information is being provided. Alternatively, for example, when a teacher is presenting information to a classroom of students and students continuously have their hands raised to ask questions, rather than remaining attentive to the information being provided, the teacher may become overwhelmed with the number of questions causing a disruption of the presentation. A disruption of a presentation will then negate the provision of necessary information from a teacher to the student.

A traditional classroom or business environment, where the presenter and the attendees are present in the same location, may provide a presenter with the ability to corral and maintain an education environment when questions become a nuisance. Being in-person can allow a user to easily accept and respond to a question in real-time upon detection that an attendee would like to ask a question. However, as businesses and education move away from a traditional, in-person environment to a virtual environment, this maintaining of a learning environment becomes harder task.

When a user is present in a virtual meeting, as an attendee of the virtual meeting, the user must determine when it would be most appropriate to ask a question pertaining to the information provided by a presenting user. Asking questions is a sign of being attentive and invested in the information, and though asking questions is commonly encouraged at all levels of being educated, whether in a workplace or a classroom, mistiming a question can lead to disruptions of presentations, and an overall loss of a train-of-thought. Sidetracking of a presenter may then, for example, lead to a need to repeat information to recenter themselves when referencing back to the information being presented, and may even result in the skipping and/or loss of information that should be have been provided to the users present in the virtual meeting.

A conventional method used to maintain order in an education environment, both in-person and virtual, is the use of a raised-hand gesture, that provides a silent indicator to a presenter that a question from a user is present. This allows the presenter to know that there is a question, but allows the presenter to wait until an appropriate time to receive and answer the question. In a traditional, in-person classroom, such a raising of the hand is blatantly easy to identify. In a virtual meeting or classroom environment, the raised-hand gesture received may be an indication present on the display of the device of a presenter. A need to answer the question after the detection of such raised-hand indicators can still provide disruptions to the presenter whether in-person or over a virtual meeting. In an attempt to overcome such disruptions, a conventional method used may be to allot a certain amount of time for attendees to ask questions after a presentation has been provided in its entirety. Though this method may negate disruptions in the presentation of the information to the attendees, withholding questions until the end of a presentation can result in an attendee not remembering specifics surrounding a question, resulting in a lengthier question requiring a recentering of information, and may result in the attendee forgetting a question as a whole. Additionally, or alternatively, allotting a time at the end of a presentation for questions may discourage attendees from asking questions because of the additional time questions make require in order to be answered. Thus, what is needed is a system that may provide an indication to the presenting user describing when a question is desired to be asked by an attending user, and providing a context of the information surrounding when the indication is received in order to accurately answer a question without a need of recentering the presenting user.

Accordingly, the described system and method provides a technique for providing the context of a question upon detection of an alert at the central device of the presenting user upon detection of indication provided by a user. The system and method may utilize an alert context identification system to provide and receive an alert initiated by a user device in communication with a central device of a presenting user, respectively. For example, when a user has a question during a presentation, the alert context identification system may receive input from the attending user when a question is to be asked, and the alert context identification system may provide the alert to the presenting user upon detection of the input. Such an alert indicates that that user would like to communicate with at least the presenting user. Additionally, upon detection of the alert, at the alert context identification system, the system and method may provide a context of the information occurring, or being presented, at the time of the alert, and thereafter, along with the alert, the system may provide the context information to the central device of the presenting user. Such a system provides a user with a method for receiving an alert indicating a requested communication along with context information in order to negate disruptions and a repetition of information during the presentation of information to a plurality of users over a virtual medium.

The illustrated example embodiments will be best understood by reference to the figures. The following description is intended only by way of example, and simply illustrates certain example embodiments.

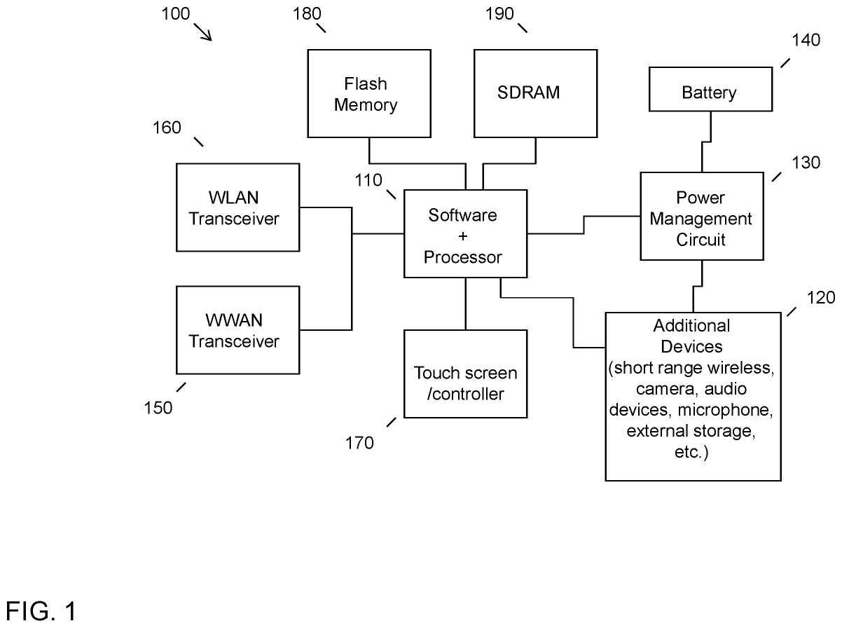

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

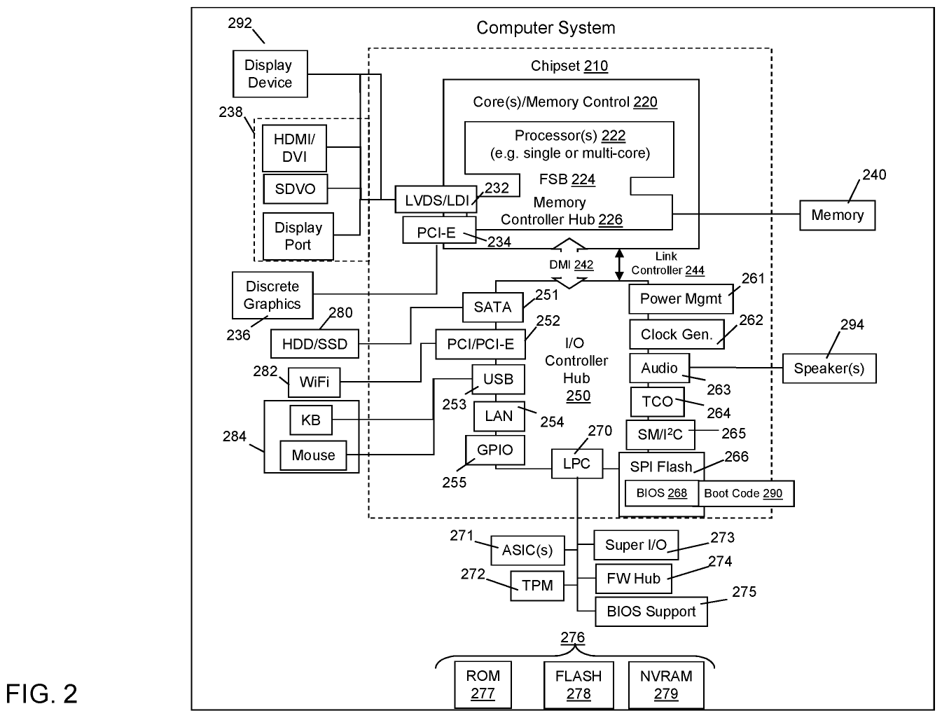

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in a system that identifies messages transmitted by a sender to at least one recipient and thereafter determines that at least one of the messages provided did not receive a response. For example, the circuitry outlined in FIG. 1 may be implemented in a tablet or smart phone embodiment, whereas the circuitry outlined in FIG. 2 may be implemented in a personal computer embodiment.

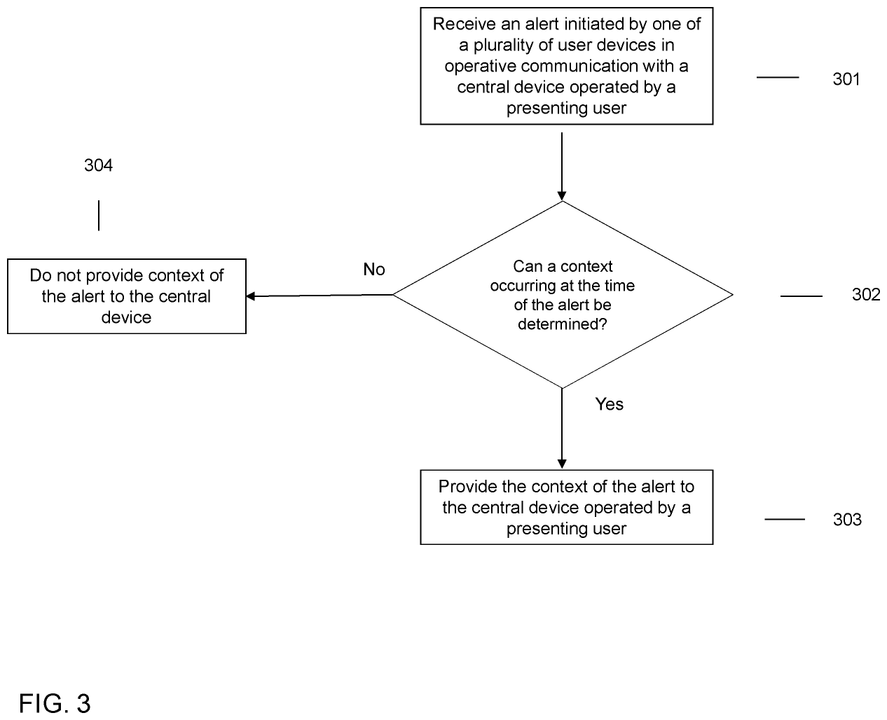

FIG. 3 illustrates an example method for providing the context with an alert to the central device of the presenting user after receiving an alert from one of a plurality of user devices in operative communication with the central device by use of an alert context identification system. The method may be implemented on a system which includes a processor, memory device, output devices (e.g., display device, etc.), input devices (e.g., keyboard, touch screen, mouse, microphones, sensors, biometric scanners, etc.), and/or other components, for example, those discussed in connection with FIG. 1 and/or FIG. 2. While the system may include known hardware and software components and/or hardware and software components developed in the future, the alert context identification system is specifically programmed to perform functions as described herein to provide, to the central device of the presenting user, the context of an alert supplied by one of the plurality of users at their device in communication with the central device.

The alert context identification system may run in the background of an information handling device and may be activated with the device is activated. Additionally, or alternatively, the system may be activated when an application associated with a virtual meeting (e.g., video conferencing platform, virtual classroom platform, messaging application, etc.) is activated, detected, or otherwise opened. The system may also be activated upon detection of an invitation to join a virtual meeting at a user information handling device. In this case, the alert context identification system may not be activated until a virtual meeting is joined at the time of the invitation from an information handling device associated with the user.

Once the alert context identification system is activated on a device, the system may be utilized throughout the process of receiving an alert initiated by one of a plurality of user devices in operative communication with a central device operated by a presenting user, determining a context occurring at the time of the alert, and providing the context with the alert to the central device. Continued use of the alert identification system identifying an alert initiated by a user and determining a context occurring at the time of the alert will train the device regarding when to provide the context surrounding the alert received by the user device to the central device of the presenting user. Additionally, the system can be trained to identify what context is useful to be provided to a presenting user. To perform the steps present in the alert context identification system and in order to accurately determine the context occurring at the time of the alert, the alert context identification system may utilize a neural network, machine-learning model, and/or other learning algorithm, collectively referred to as a machine-learning model for ease of readability. The machine-learning model can be trained utilizing previously received alerts from a plurality of users and the context surrounding such alerts. In other words, the machine-learning model is given access to previously established alerts initiated by a user that may or may not have a context determined to accompany the alert. Additionally, the machine-learning model receives parsed alerts and contexts of the alerts outlining specific contexts and topics associated with information presented to the user virtual meetings so that the machine-learning model can accurately identify different contexts of the alerts that require a response. These established alerts and their associated contexts that were thereafter provided to the central device of the presenting user are referred to as a training dataset, which may be one or more training datasets.

Using the training dataset(s), which may change over time, the machine-learning model learns nuances between the alerts received from a user device at a central device of the presenting user and the context of these alerts. This results in more accurately identifying the contexts of each alert provided by a user through the alert context identification system. For example, the machine-learning model can learn when an alert is provided by the user and received at the central device of the presenting user, and even more specifically, determine the context surrounding the alert from the information being presented by the presenting user at the time the alert is received. The model may also learn how to determine one or more topics and/or main ideas that are present in the context when receiving an alert at the central device of the presenting user. As contextual information is determined in associated as to when the alert is provided/received, the machine-learning model can learn additional nuances and become more refined over time. Thus, while there is an initial training dataset that is used to initially train the machine-learning model, the machine-learning model is learning over time based upon new information received by the machine-learning model, thereby evolving to become more accurate. This is generally referred to as a reinforcement training. Other techniques for training the machine-learning model(s) are contemplated and possible, including, unsupervised learning, a combination of learning techniques, and/or the like.

At 301, the alert context identification system may receive an alert initiated by one of a plurality of user devices in operative communication with a central device operated by a presenting user. Receiving an alert initiated by a user in communication with a central device operated by a presenting user may permit a user to supply an indication to the central device of the presenting user describing a question. The alert context identification system may include a graphical user interface that includes one or more alert icons that when selected by a user may initiate an alert to be provided to the central device of the presenting user. An alert icon may be present on the on the graphical user interface of the user device and on the graphical user interface of the device of the presenting user, but may only be selected on the device of the user. In the system, when a user is decides to ask a question or wants to provide commentary or otherwise communicate with the presenting user, a user may first select the alert icon to notify the presenting user of the question or communication.

Selecting of the alert icon may include clicking a button to provide the notification, toggling an indicator present on the graphical user interface, and/or the like. Upon selection of the alert icon on the user device, an alert may then be provided to the central device of the presenting user. For example, the alert icon may be the icon of a hand present adjacent to the name of the user. Upon selection of the clicking of the hand-icon, the icon may change colors on both the graphical user interface of a communication medium being utilized, initiating an alert being provided to the central device of the presenting user. In other words, once an alert icon has been selected at the device of the user, an alert is sent to the device of the presenting user. For ease of understanding and readability, the alert that will be discussed herein is a raised-hand gesture, meaning that an icon selection of a hand-icon may initiate an alert at the central device of the presenting user. However, this is not intended to be a limiting example. Rather, any type of alert consistent with initiating an indication to the presenting user may be utilized herein. Additionally, the example communication of a question will be used here throughout. However, other types of communication are contemplated and possible, for example, commentary, additional information, a remark, and/or the like.

As a central device receives an alert initiated by one or a plurality of user devices in operative communication with a central device operated by a presenting user, at 301, the user providing the indication for alert may provide a question alongside the alert. In the system, immediately subsequent to selecting an indicator, the user may provide a summary of the question to be asked to the presenting user. In the system, the provision of the question may include providing a typed-out question present in an applicable question-asking portion of the graphical user interface in use, for example, a chat window present over a virtual meeting interface. Additionally, or alternatively, in the system, a question may be audibly provided by the user upon identification and response to the alert provided by the user. For example, after selecting the raised-hand gesture icon, a presenting user may inquire about the question from the user, and the user may verbally provide the question to the presenting user. In the system, an alert may only be initiated when a user has a question or wants to provide a communication. Failure to provide a communication after selecting an indicator causing an alert on a central device of the presenting user may be ignored by the system and/or the presenting user.

In the system, a virtual medium, for example, a video-conferencing application, may be established and hosted by a presenting user. The device of the presenting user may be known as the central device of the system, because the central device of the system will receive each alert initiated by a user present during a presentation over a virtual medium, it is interconnected with the other user devices, and is generally the device that is controlling the flow of the presentation material, for example, the device of the teacher. The number of users present in the virtual medium is not limited by this system; however, the support of a plurality of users may be influenced by the virtual medium itself and/or other network factors (e.g., bandwidth availability, a limit on a number of devices that may access a presentation via a specific virtual medium, etc.).

A plurality of users accesses the presentation over a supportive virtual medium. For example, the setting may be a virtual classroom containing a presenting user (e.g., teacher) and a plurality of users (e.g., students). Additionally, or alternatively, for example, the setting may be a virtual business meeting containing a presenting user (e.g., a director) and a plurality of users (e.g., subordinates). The alert context identification system may be employed in any virtual meeting environment that includes a presenting user and at least one user attending the presentation virtually. Throughout this specification, reference to a classroom environment may be present; however, this is intended to be a non-limiting example. Additionally, reference to a presentation is used here throughout. However, this is not intended to limit the scope of this disclosure to a slideshow, as other presentation types are contemplated and possible, for example, screen sharing, virtual classroom, video presentations, audio presentations, a combination thereof, and/or the like.

Each of the plurality of user devices in operative communication with a central device operated by the presenting user may include a graphical user interface that is accessible by each of the devices. While the graphical user interface may be facilitated by the central device or presentation software and may, therefore be similar between devices, each device may somewhat configure the graphical user interface. Additionally, each user may interface with the user interface in a manner that does not change the interface of other devices. For example, if a user interfaces with an icon on the graphical user interface present on that user's device, that does not necessarily cause that icon to change on other user devices graphical user interface. However, some icons may include features that cause changes to other user device interfaces. Additionally, the central device may be able to at least partially control the interfaces of the user devices.

In a virtual classroom environment, the host or central device of the virtual classroom may be the device of the presenting user, or the teacher, and the plurality of user devices in the operative communication with the central device, or the teacher's device, are the devices associated with each student. In the system, the central device of the teacher hosting the virtual classroom may be the device that receives an alert that is initiated by one of the plurality of student devices. In the system, when one of the plurality of student devices selects an alert icon on the graphical user interface of the virtual communication medium in use, only the host device will be notified of the alert. Additionally, or alternatively, in the system, upon selection of an alert icon by one of the plurality of student devices in the virtual classroom, an alert may be provided to only the teacher device but each additional student device may be able to view that one user has a question. For example, upon selecting the hand-icon by use of the raised-hand gesture, the hand-icon for the user initiating the alert may change color on the graphical user interface of the virtual classroom being viewed by all additional students in the virtual classroom. Additionally, or alternatively, in the system, upon selection of the alert icon by one of the plurality of student devices, the student device that initiated the alert may select one or more additional students to receive the alert in combination with the teacher device. For example, the user initiating the alert may select an additional student to receive the alert because a question of the current student may stem from a question previously asked by another student; therefore, in this example, the alert initiating a question may be supplied to the teacher device and the at least one additional student device.

After receiving an alert initiated by one of a plurality of user devices in operative communication in with a central device operated by a presenting user, at 301, the alert context identification system may attempt to determine a context occurring at the time of the alert at 302. For example, upon detecting the alert the alert context identification system may attempt to determine, at 302, when the alert is provided and identify one or more pieces of additional information that are present at the time of the alert. It should be noted that the information occurring at the time of the alert may include information that has occurred before, at the exact same time, and after the time of the alert. In other words, the time of the alert may be a window of time surrounding the alert. The length of the window of time may be user configurable, a default value, learned over time by the system, for example, using a machine-learning model, and/or the like.

Determining the context surrounding the time of the alert, at 302, may assist the presenting user in potentially providing an accurate response back to a user in a timely manner. In the system, when it is determined, at 302, that a context occurring at the time of an alert cannot be determined, the alert context identification system may not provide the context of the alert to the central device in communication with a plurality of user devices, at 304. However, when it is determined, at 302, that the context surrounding the time of the alert can be determined, the alert context identification system may provide, at 303, the context with the alert to the central device operated by a presenting user.

When attempting to determine a context surrounding the time of the alert at 302, the system may first attempt to narrow down the time which the alert, at 301, is provided by the user at the user device and received by the central device of the presenting user. For example, the system may identify a timestamp of the alert or selection of the alert icon. Determining the context may include identifying a location within a presentation being presented by the presenting user that occurs at the time of the alert. The presentation being presented by the presenting user over a virtual medium to a plurality of users includes a finite amount of information, and therefore, a finite amount of time that a presentation may be ongoing, This amount of time is able to be measured and recorded, for example, utilizing time stamps of events that occur with the presentation (e.g., changing of slides, changing of topics, selection of portions of the presentation, movement of graphical user interface elements, etc.), that can then be correlated to the time stamp of the alert, thereby allowing the system to identify information that was active at the time of the alert.

For example, the presentation being presented by the presenting user, or the teacher, may include ten slides of information. Of the ten slides of information, pairs of slides may encompass a single specific topic touching on an overall topic (e.g., an overall topic of small dog breeds may include five different dog breeds discussed two slides at a time). As a teacher is presenting the small dog breed information, an alert is initiated and determined to be received while the teacher is speaking about pugs on the 4^{th} slide of the 10-piece slide presentation. The alert context identification system may record that the teacher was speaking on pugs at slide 4 and provide this location information alongside the alert, and the question within the alert (if provided). Thus, when the teacher decides to address the question, the context information can provide additional information to help center the teacher and, thereafter, provide an accurate response to the question that user may have. Specifically, continuing the example, the question accompanying the alert received at the central device of the teacher, may include, “why are the snouts squished unlike other dogs?” Without a context of the question occurring at a time of the alert, answering such a question will require a dialogue between the student asking the question and the teacher describing that the user is asking about a pug. Thus, by identifying a location within a presentation (e.g., the 4^{th} slide of the dog breed presentation containing 10 slides) and presenting such information location information to the presenting user occurring at the time of the alert, the context information may permit a user to understand a question in its entirety without the need of querying for additional information, and therefore, may provide a quick and accurate response to the user's question with little to no disruption of the presentation.

Other context information may include audio content occurring at the time of the alert. The alert context identification system may parse audio content provided at the time of the alert and extract at least one topic from the parsed audio content. Audio content, similar to a presentation, is provided within a finite time window. Once a presenting user starts providing audio to a plurality of users attending a presentation over a virtual communication medium, a timestamp may be established when an alert is initiated in relation to what the presenting user is talking about when the alert is received. The timestamp of the alert can be compared to the parsed audio and corresponding timestamps to determine a topic that was discussed at the time of the alert. The alert context identification system may utilize one or more natural language processing techniques to identify a topic a presenting user is discussing at the time an alert is initiated by a user.

For example, if a teacher is giving a verbal presentation on small dog breeds and a user provides an alert for a question 3 minutes and 45 seconds into the verbal presentation, the alert context identification system may record the timestamp of when the alert is received at the central device of the teacher. The system may thereafter utilize audio parsing and natural language processing techniques to determine that the teacher was discussing dachshunds. Then, when the teacher views the alert containing the question, “why do they have such long bodies and short legs?” the teacher may identify that the student is referencing the dachshund. Once again, this contextual information being supplied alongside the alert and question of the student to the teacher permits the teacher to respond quickly and accurately.

Another technique for identifying the context may be to access a secondary information source and identify, from the secondary information source, a topic of a presentation being presented by the presenting user. A secondary information source may be any information source provided by a presenting user to a user that further supports an ongoing presentation. For example, while a teacher is providing a verbal presentation on small dog breeds, the teacher may instruct the students to reference a secondary source providing illustrations of the dog breeds that the teacher is discussing. While the teacher is giving the verbal presentation on small dog breeds, a reference to the secondary information source may be made describing the coat of a Maltese. Though typically shorter and messy, the coat of a Maltese may be kept long and well groomed when such a dog is used for competition. While reference to the coat of a Maltese is being discussed by the teacher and the secondary information source is being viewed by the user, and an alert is initiated by a user having a question, the alert context identification system may record when the alert in received at the teacher device and which part of the secondary information source was being referenced at this time. Therefore, when a question accompanying the alert states, “is it harder to maintain a longer coat than a shorter coat?” the teacher will be made aware that student is asking about the Maltese because the context surrounding the secondary information source will include a reference to the Maltese that was recorded at the time of the alert.

As another example, the system may access an agenda, class schedule, previous presentations, and/or the like, to identify particular times that something may have been discussed. These are merely examples and other secondary information sources can be accessed to identify possible topics or information that was presented at a particular time, possible sources that were being referenced by the presenting user and/or user at a particular time, and/or the like. A secondary information source may be utilized as context information during any presentation style. Previous reference to a secondary information source being supplied alongside a verbal presentation is disclosed. However, this is intended to be a non-limiting example.

Another type of context may include additional information supplied from the user to the presenting user. The additional information may include the question that may have been included with the initiation of the alert. Additionally, the user may supply additional, specific information in support of the question. For example, while a teacher is providing a presentation on small dog breeds to a class, a student may initiate an alert for a question centered around why small dogs have a higher pitched bark. Upon providing the alert and the question, “why do small dogs have a higher pitched bark?” the user may then select portions of a presentation that include a pitch of the bark of a small dog in comparison to a pitch of a medium dog's bark and another portion of the presentation that compares the pitch of a small dog's bark against a large dog's bark. In the system, the student may elect to provide one piece of additional information discussing dog bark pitch. Additionally, or alternatively, in the system, the student may elect to provide a plurality of pieces of additional information discussing dog bark pitch, for example, more than one occurrence where dog bark pitch is discussed in the presentation. Then, when the presenting user, or teacher, gets around to viewing and/or responding to the question present within the received alert, each piece of additional information selected by the student is presented to the teacher. Such a background of information may assist the presenting user, or teacher, with answering the question in a clear and concise manner.

After the context surrounding the time of the alert is determined, at 302, the context is provided with the alert to the central device operated by the presenting user, at 303. This providing of the context, at 303, includes receipt of all additional information collected by the alert context identification system that may be referenced in support of answering the question associated with the alert. In the system, providing the context, at 303, includes providing the context information upon initiating the alert. Further, providing the context with the alert 303 includes providing the context information over the virtual communication medium. In the system, the alert, question, and context information may be viewed on a display of the central device of the presenting user. In the system, the graphical user interface of the virtual communication medium in use may have a designated conversation portion (e.g., a chat box, messaging application, etc.). Additionally, or alternatively, in the system, the context of the alert may be supplied via any text-based communication method (e.g., email application, messaging application, social media messaging application, etc.).

In the system, when providing a context of the alert to the central device operated by a presenting user, at 303, the alert context identification system may determine that a response to the question accompanying the alert may be suggested based upon information contained within a presentation being presented by the user. In other words, the alert context identification system may utilize a machine-learning model to produce a suggested response for a presenting user to supply back to the user asking the question. In the system, the alert context identification system may identify one or more topics and sub-topics present in a presentation being given by the presenting user. Upon receiving an alert initiated by a user, the alert context identification system may interpret the question provided by the user by use of natural language processing techniques, and based upon the information present in the presentation, produce a suggestion for response to the question.

In the system, suggesting a response may include identifying a response to the question supplied by the user was previously presented in the ongoing presentation. For example, as a presenting user is giving a presentation on small dog breeds, a user may supply the question asking what size specifications establish a dog as a small dog breed, which is a topic that was discussed at the very beginning of the presentation. Since the presenting user is not talking on such information at this point of the presentation, the system may provide a suggestion for response to the presenting user to supply back to the user, for example, “refer back to slide 1 of the presentation for the topic of general size requirements for small dog breeds.” Rather than requiring the presenting user to repeat themselves by answering a question that has already been covered in the presentation, the alert context identification system may provide a suggestion for response to the presenting user, and may thereafter supply the response back to the user under the presenting user's discretion. In the system, the suggestion generated by the alert context identification system may be edited by the presenting user prior to be being supplied back to the user. In the system, suggesting the response back may reference previously supplied responses to similar questions, and may utilize one or more machine-learning techniques in combination with the previously supplied responses to similar questions to generate an answer to the question accompanying the alert.

Additionally, or alternatively, in the system, suggesting a response generated by the alert context identification system may include a response that the information being questioned will receive an answer in the upcoming information in the presentation. In other words, rather than supplying a response to a question discussing a topic that has not been discussed yet, but will be later on in the presentation, the suggested response generated by the alert context identification system may notify the user that an answer to the user's question will be supplied in time.

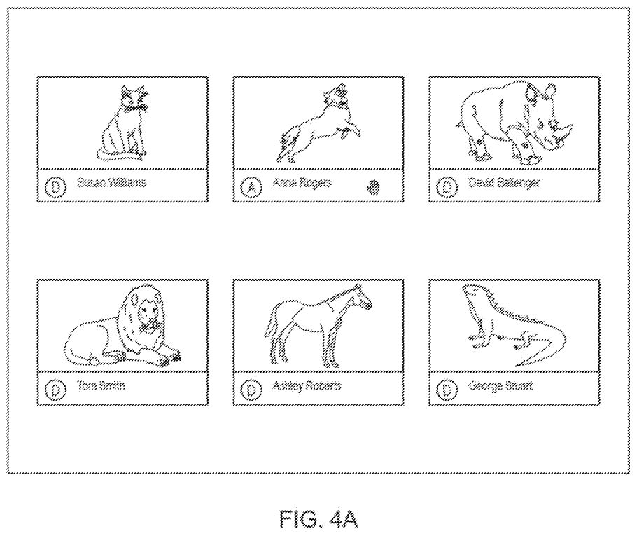

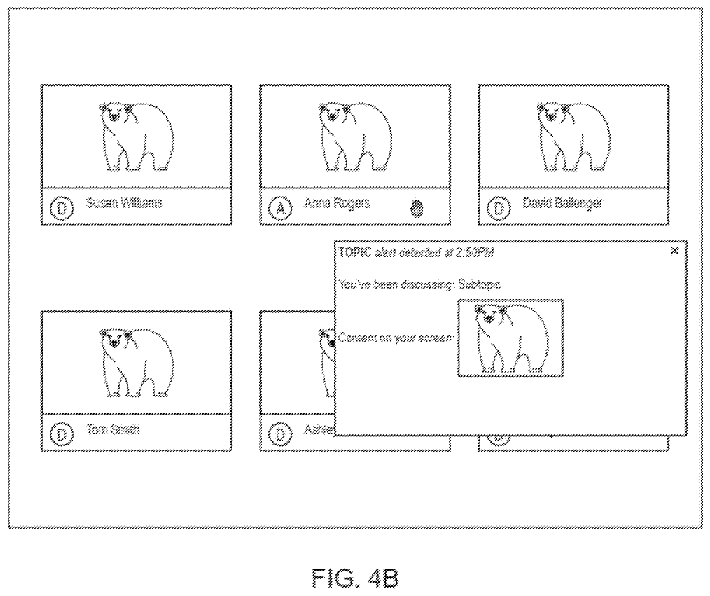

FIG. 4A illustrates an example raised-hand gesture received during a virtual meeting as seen by a user in operative communication with a central device of a presenting user. As illustrated in FIG. 4A, the hand-icon is present and colored in adjacent to the name “Anna Rogers.” The presence of this colored, hand-icon illustrates that Anna has a question and that Anna initiated an alert to be provided to the presenting user. In the system, Anna and the presenting user may be the only users able to see the alert indication. Additionally, or alternatively, all users present in the virtual meeting may be able to view the hand-icon illustrating that Anna has a question. Additionally, or alternatively, Anna may select which additional users within the virtual meeting may also view the hand-icon initiating the alert that she has a question.

FIG. 4B illustrates an example raised-hand gesture received during a virtual meeting as seen by a presenting user in communication with a plurality of users. In the system, even in the embodiments in which Anna may elect to show additional users in the virtual meeting that she has initiated an alert to ask a question, only a presenting user may see the text box including the question accompanying the alert, and any additional information associated with the question. Rather than supplying the question to all users present in the virtual meeting, the presenting user only receives the question and additional information because such supplying of information to each additional user may result in disruption of the presentation, for example, if one or more of the additional users (not the presenting user) attempt to answer the question of Anna. However, the information may also be supplied to other users and whether the information is supplied may be based upon user preferences, default settings, a type of application being utilized, and/or the like.

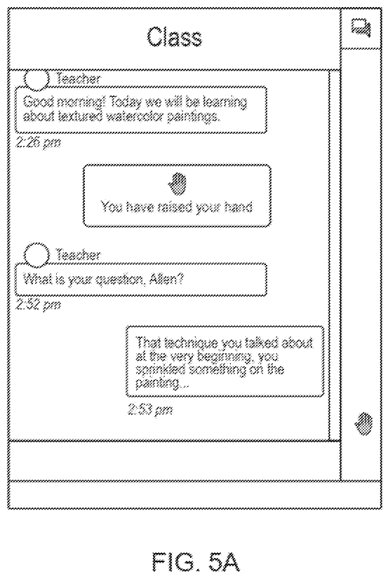

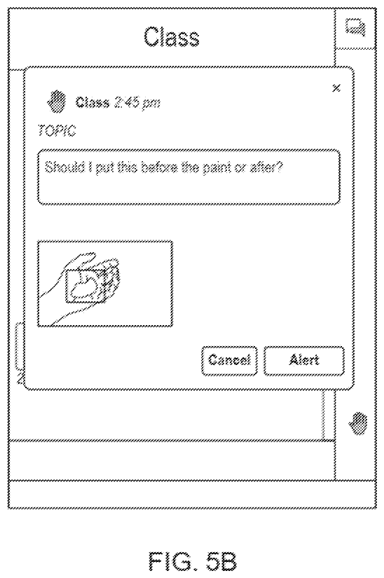

FIG. 5A illustrates an example raised-hand gesture received via a chat window present in the graphical user interface of a virtual meeting as seen by the user. As can be seen in the illustration, prior to the teacher asking, “what is your question, Allen?” a raised-hand gesture and/or the hand-icon is supplied within a chat window and at a specific time. This recording of when the alert is provided assists in establishing the context of the alert and question. FIG. 5B illustrates an example method of providing additional information from the user device in support of the question provided. As Allen is providing the question to the teacher, or presenting user, the alert context identification system allows Allen, or the user, to input additional contextual information in support of their question in an attempt to clearly supply the question at hand. As can be seen in FIG. 5B, Allen elected to include the additional information of an image with a shape outlining a portion of the image that he is specifically referencing. This additional information will assist the teacher, or the presenting user, in responding to the question quickly and accurately.

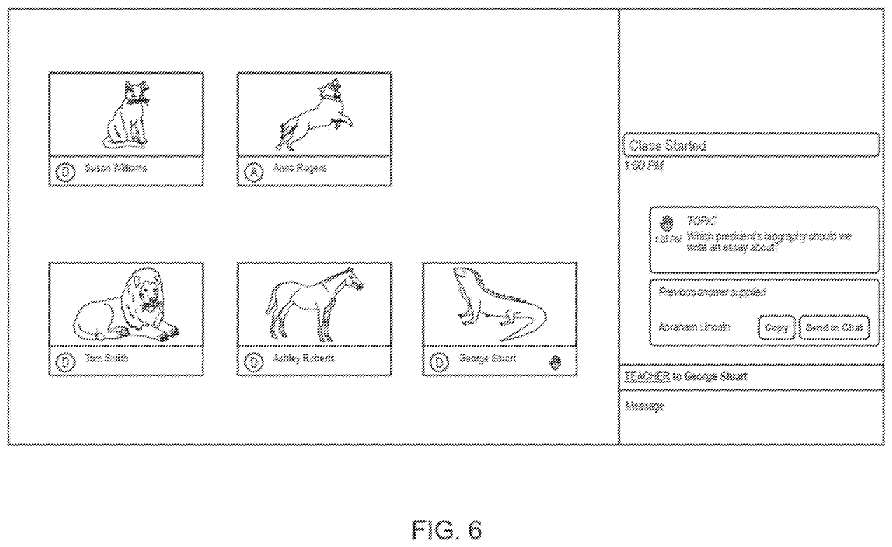

FIG. 6. illustrates an example raised-hand gesture received during a virtual meeting and suggesting a response to the user based upon previously supplied information as seen by the presenting user. As can be seen in the left-most portion of FIG. 6, George Stuart has a colored hand-icon present next to his name, illustrating the initiation of an alert containing a question that is supplied to the central device of the presenting user. The question that George has asked can be seen in the right-most portion of the figure, and is present within a chat window. The question reading, “Which president's biography should we write an essay about?” receives a generated suggested response produced by the alert context identification system for this question has been either (1) previously presented or (2) been asked previously. The suggestion is provided to the presenting user, and then based upon the generated response, the presenting user may elect to supply the response as generated, may edit the generated response for accuracy, or many elect to not send the response all together.

The various embodiments herein thus describe a technical improvement over conventional methods for providing a response to a question while operating over a virtual communication medium. The alert context identification system permits the collection of context data surrounding a question of a user upon the detection of an alert that the user has a question. Rather than utilizing traditional methods that require a user asking a question to supply centering information in combination with a question, an alert context identification system may collect context data, and may further permit the inclusion of additional data associated with the context as supplied by the user. Such a system and method may allow a presenting user giving a presentation to relay information to a plurality of users present within the virtual communication medium with minimal disruption; thus, providing a clear presentation of the information present and responding to questions in quick and accurate manner.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving, at an alert context identification system, an alert initiated by one of a plurality of user devices in operative communication with a central device operated by a presenting user, wherein the alert indicates a user of the one of the plurality of user devices wants to communicate at least with the presenting user;
determining, utilizing the alert context identification system, a context occurring at a time of the alert; and
providing, to the central device and utilizing the alert context identification system, the context with the alert.

2. The method of claim 1, wherein the alert is initiated responsive to the user selecting an alert icon within a graphical user interface of the one of the plurality of user devices.

3. The method of claim 1, wherein the determining a context comprises identifying a location within a presentation being presented by the presenting user and occurring at the time of the alert.

4. The method of claim 1, wherein the determining a context comprises parsing audio content provided at the time of the alert and extracting at least one topic from the parsed audio content.

5. The method of claim 1, wherein the determining a context comprises accessing a secondary information source and identifying, from the secondary information source, a topic of a presentation being presented by the presenting user.

6. The method of claim 1, wherein the determining a context comprises receiving additional information from the user of the one of the plurality of user devices in combination with the alert initiated by the user.

7. The method of claim 1, further comprising suggesting a response to the user based upon information contained within a presentation being presented by the presenting user.

8. The method of claim 7, wherein the suggesting a response comprises identifying a response to the user within the presentation.

9. The method of claim 7, wherein the suggesting a response comprises indicating a response is upcoming within the presentation.

10. The method of claim 1, wherein the determining a context comprises utilizing a machine-learning model.

11. An information handling device, the information handling device comprising:
a processor;
a memory device that stores instructions that when executed by the processor, causes the information handling device to:
receive, at an alert context identification system, an alert initiated by one of a plurality of user devices in operative communication with a central device operated by a presenting user, wherein the alert indicates a user of the one of the plurality of user devices wants to communicate at least with the presenting user;
determine, utilizing the alert context identification system, a context occurring at a time of the alert; and
provide, to the central device and utilizing the alert context identification system, the context with the alert.

12. The information handling device of claim 11, wherein the alert is initiated responsive to the user selecting an alert icon within a graphical user interface of the one of the plurality of user devices.

13. The information handling device of claim 11, wherein to determine a context comprises identifying a location within a presentation being presented by the presenting and occurring at the time of the alert.

14. The information handling device of claim 11, wherein to determine a content comprises parsing audio content provided at the time of the alert and extracting at least one topic from the parsed audio content.

15. The information handling device of claim 11, wherein to determine a context comprises accessing a secondary information source and identifying, from the secondary information source, a topic of a presentation being presented by the presenting user.

16. The information handling device of claim 11, wherein to determine a context comprises receiving additional information from the user of the one of the plurality of user devices in combination with the alert initiated by the user.

17. The information handling device of claim 11, further comprising suggesting a response to the user based upon information contained within a presentation being presented by the user.

18. The information handling device of claim 17, wherein the suggesting a response comprises identifying a response to the user within the presentation.

19. The information handling device of claim 17, wherein the suggesting a response comprises indicating a response is upcoming in the presentation.

20. A product, the product comprising:
a computer-readable storage device that stores executable code that, when executed by a processor, causes the product to:
receive, at an alert context identification system, an alert initiated by one of a plurality of user devices in operative communication with a central device operated by a presenting user, wherein the alert indicates a user of the of the one of the plurality of user devices wants to communicate at least with the presenting user;
determine, utilizing the alert context identification system, a context occurring at a time of the alert; and
provide, to the central device and utilizing the alert context identification system, the context within the alert.
